(19) United States
(12) Patent Application Publication
(10) Pub. No.: US 2015/0019193 A1
(43) Pub. Date: Jan. 15, 2015

(54) VERIFICATION USING GENERIC PROTOCOL ADAPTERS

(71) Applicant: QUALCOMM TECHNOLOGIES, INC., San Diego, CA (US)

(72) Inventors: Boris BOUTILLIER, Montigny-le-Bretonneux (FR); Jean-Jacques LECLER, Sunnyvale, CA (US)

(73) Assignee: QUALCOMM TECHNOLOGIES, INC.

(21) Appl. No.: 13/941,535

(22) Filed: Jul. 14, 2013

(51) Int. Cl. G06F 17/50

(52) U.S. Cl. CPC G06F 17/5036
USPC 703/14

(57) ABSTRACT

Verification IPs for the verification of semiconductor chip designs are designed to support specific interface protocols. Verification IP is expensive or unavailable to test devices with interfaces of uncommon protocols. Verification IP that uses a generic interface protocol, used in conjunction with simple adapters between interfaces of the VIP that use the generic protocol and interfaces of the device under test that use specific protocols, are reused to test interfaces with different specific protocols if the generic protocol supports a superset of the features of the specific protocols.

### FIELD OF THE INVENTION

The claimed invention is in the field of computer aided semiconductor design verification and, more specifically, interface protocols for verification intellectual property.

### BACKGROUND

Chips are designed modularly with intellectual properties (IPs) from different developers. Interfaces between IPs have a master side and a slave side. The sides communicate by performing read transactions and write transactions according to a protocol. Some examples of such protocols are: Advanced Microcontroller Bus Architecture (AMBA), Advanced eXtensible Interface (AXI), and Open Core Protocol (OCP).

Chip designs are verified within a testbench with verification intellectual properties (VIPs). This is usually done with simulations of models of the device under test (DUT), but sometimes through other means such as formal proofs or building prototypes. VIPs are programs that perform functions such as stimulating parts of the DUT by generating transactions (transactors), monitoring the response of the system in terms of generated transactions with a scoreboard (monitors), checking adherence to protocols, determining which states have been achieved (covered) by testing, and providing debugging information. VIPs that issue transaction requests and responses at the interfaces of a DUT are known as drivers. VIPs that observe the behavior of a DUT at interfaces are known as monitors. Simulations that include VIP are generally built using industry standard methodologies such as verification methodology manual (VMM), open verification methodology (OVM), or universal verification methodology (UVM).

VIPs are controlled by verification engineers through application programming interfaces (APIs). Even for a given verification methodology, VIPs from different developers have significantly different APIs. Even for a given developer, VIPs for different protocols necessarily have differences in their APIs. No vendor provides VIP for every rarely used protocol, so for DUTs with uncommon protocols APIs used for implementing a verification testbench are sure to be many.

Furthermore, VIP for uncommon and proprietary interface protocols is only available at a high price or not at all. This limits the ability of designers to easily perform adequate verification.

Therefore what is needed is system and method to do verification with a uniform API supporting a diverse range of interface protocols.

### SUMMARY OF THE INVENTION

A system and method are disclosed wherein verification is performed using VIPs that use a generic protocol. A generic protocol is a protocol with a superset of features of at least two specific protocols that are both not supersets of each other. For example, a protocol that supports two-dimensional block bursts and narrow bursts is generic with respect to OCP and AXI because two-dimensional block bursts is a feature of OCP but not of AXI and narrow bursts is a feature of AXI but not of OCP.

To enable verification using VIPs that use a generic protocol, adapters are used that adapt DUT interfaces of specific protocols to the generic protocol. As a result, VIPs need not be procured for specific interface protocols and only a single API need be used to develop tests.

### BRIEF DESCRIPTION OF THE DRAWINGS

FIG. 1 is a table of protocol features supported by industry standard interface protocols and a superset generic protocol according to the present invention.

FIG. 2 illustrates a system of a DUT, two VIPs, and two adapters according to the present invention.

FIG. 3 illustrates a system of a DUT, a stimuli generator, two different interface monitors, and a scoreboard according to the present invention.

FIG. 4 illustrates a set of protocol features exercised by a generic VIP and by the driver of the specific socket interface according to the present invention.

### DETAILED DESCRIPTION

The various aspects of the present invention may be implemented in software, hardware, application logic, or a combination of software, hardware, and application logic. The software, application logic and/or hardware may reside on a server, an electronic device, or a service. If desired, part of the software, application logic and/or hardware may reside on an electronic device, part of the software, application logic and/or hardware may reside on a server.

When verifying a DUT that has an interface that uses a protocol for which it is difficult to procure VIP, one might be tempted to choose a popular protocol that is well supported by VIPs; connect a bridge that adapts the specific protocol of the interface of the DUT to the popular protocol; and perform verification of the DUT using VIPs for the popular protocol. However, in order to adapt one protocol to another in a compliant way, a bridge must, in some cases, perform transformations on transactions. For example, a bridge between an AXI master interface of a DUT and AHB slave VIP would require legal AXI transactions with non-consecutive byte enables to be split into multiple AHB transactions of smaller size. Furthermore, a bridge might be unable to stimulate all protocol features of a DUT interface. For example, a bridge between an AXI master VIP and OCP slave interface of a DUT would be unable to test requests of OCP 2D burst transactions because that OCP feature is not supported by the AXI protocol.

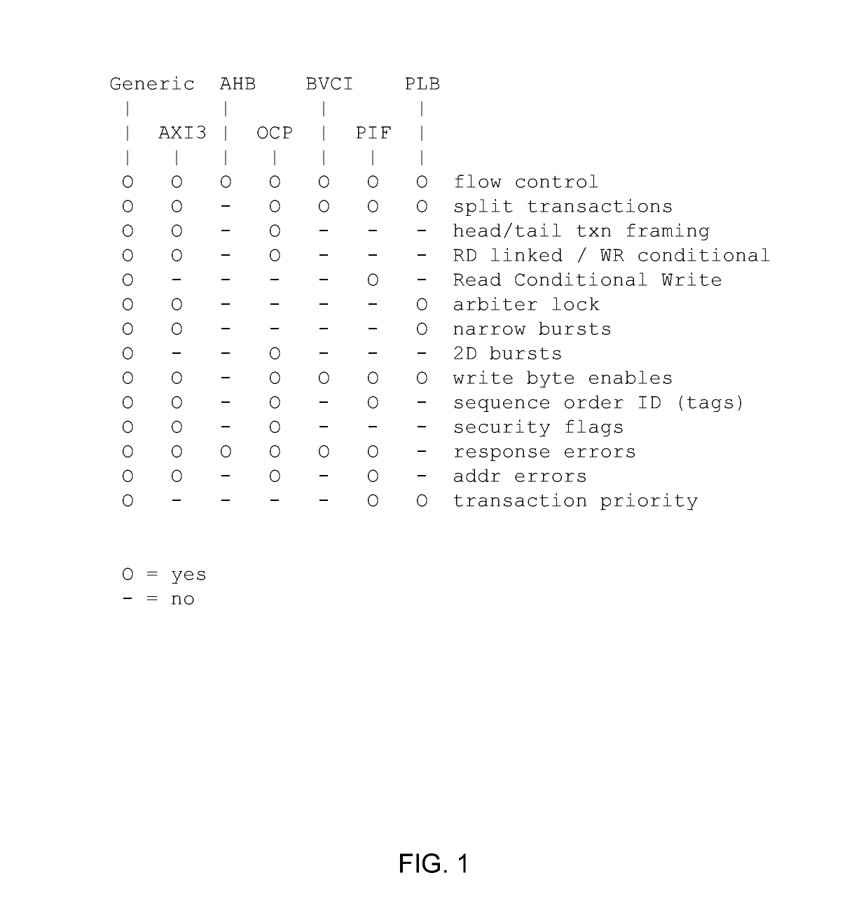

According to the present invention, an appropriate generic protocol is one that implements all or at least many of the features of all of the specific interfaces that are supported by the generic VIP. FIG. 1 shows a table of specific industry standard protocols in columns, and features in rows. The protocols in FIG. 1 include Advanced eXtensible Interface (AXI), Advanced High performance Bus (AHB), Open Cores Protocol (OCP), Basic Virtual Component Interface (BVCI), Processor InterFace (PIF), and Processor Local Bus (PLB). Other proprietary protocols exist for which no specification is published. The table indicates which features are supported by each specific protocol. A generic protocol, according to the invention, is shown in the left-most column. It supports the superset of features of all of the specific protocols.

Because a VIP for the generic protocol supports the features of a specific protocol, the logic needed to adapt one interface protocol to another is minimal. An adapter between a specific protocol interface and generic protocol interface is thin in terms of required logic depth.

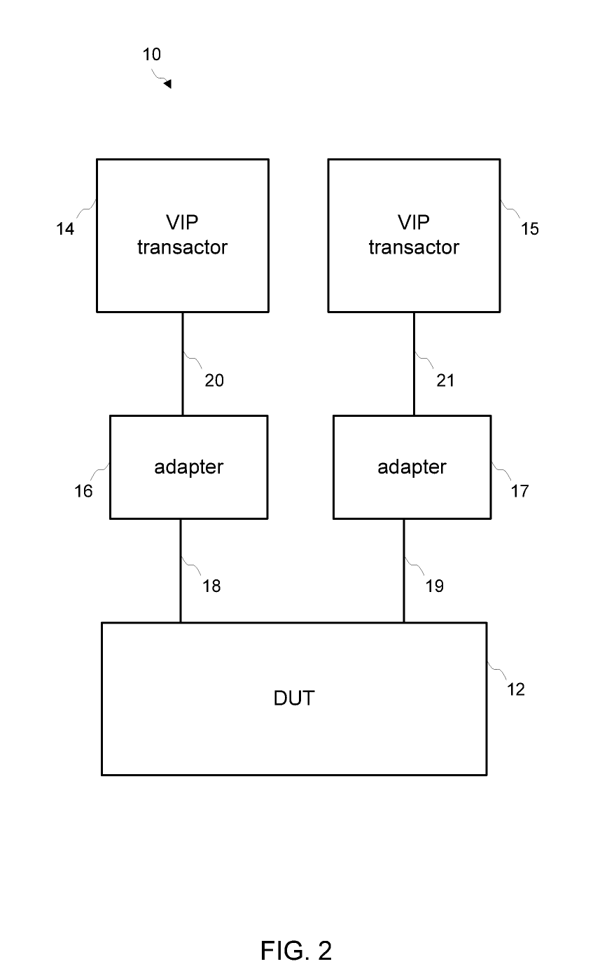

FIG. 2 shows a system 10, according to one aspect of the present invention, for the verification of DUT 12. VIP transactor 14 is connected to adapter 16, which is also connected to DUT 12. VIP 15 is connected to adapter 17, which is also connected to DUT 12. DUT 12 transacts with adapter 16 using a specific protocol on interface 18. DUT 12 transacts with adapter 17 using a different specific protocol on interface 19. Adapter 16 converts between the specific protocol of interface 18 and a generic protocol used to transact with VIP 14 on interface 20. Adapter 17 converts between the specific protocol of interface 19 and a generic protocol used to transact with VIP 15 on interface 21. According to an aspect of the invention, adapters are for initiator or target interfaces of the DUT.

A fundamental aspect of one embodiment of a generic protocol is that the amount of data accessed by a transaction is independent of the data bus width. A field describing each transaction indicates the address of the first byte accessed and another field indicates the length of data accessed in consecutive bytes. Different specific protocols have different restrictions on the allowable sizes and alignments of data accesses, but the workings of any specific interface protocol are supported by the embodiment.

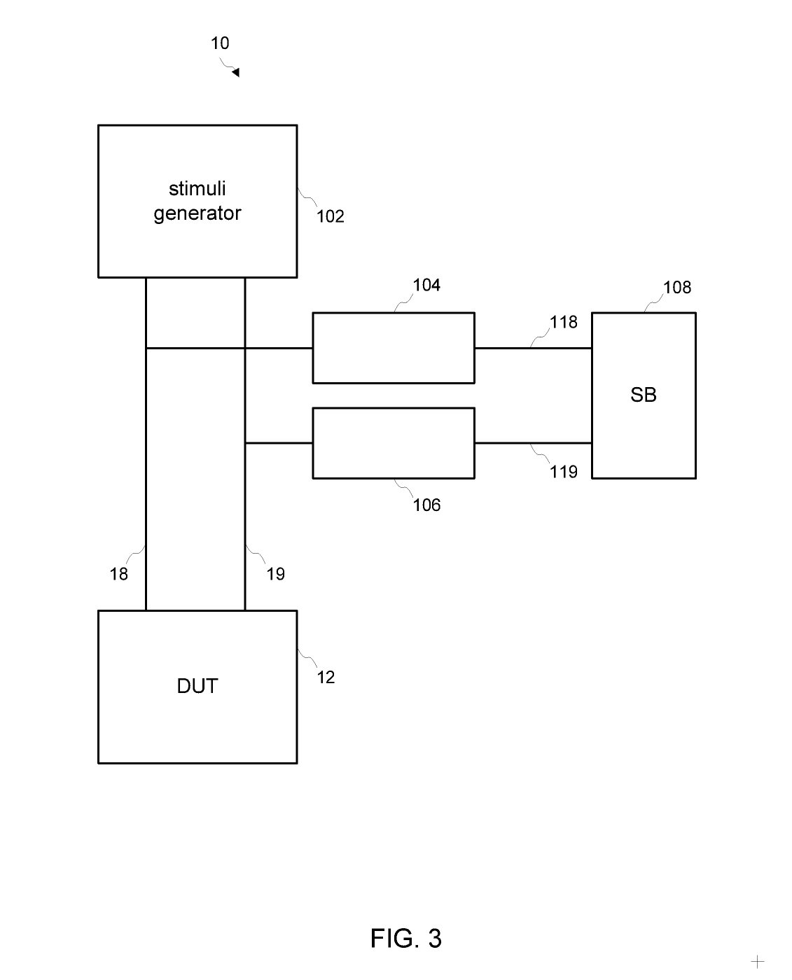

FIG. 3 shows the system 10, according to another aspect of the present invention, where stimuli generator 102 transacts with DUT 12 using two specific protocol interfaces 18 and 19. The stimuli generator 102 includes transactor VIPs 14 and 15 and adapters 16 and 17. In accordance with another aspect, the stimuli generator 102 does not use transactors or adapters. A scoreboard 108 verifies the compliance of DUT 12, regarding some predefined rules. Monitor 104 observes transactions on specific protocol interface 18, abstracts them into transactions of a generic protocol, and transfers them to scoreboard 108 through channel 118. Likewise, monitor 106 observes transactions on specific protocol interface 19, abstracts them into transactions of the generic protocol, and transfers them to scoreboard 108 through channel 119. Transactions passed on channels 118 and 119 may be encoded as hardware signals, or represented in a more abstract format like System Verilog class. As transactions passed on channels 118 and 119 use the same format, scoreboard 108 may correlate information passed on specific protocol interfaces 18 and 19, and verify the compliance of those correlations with regard to certain predefined rules, despite the fact the specific protocols used are different.

According to one aspect of the invention, generic transactions passed on channels 118 and 119 are one byte long. The scoreboard is byte-based. Transactions and even words may span ranges between target IPs, requiring splitting. The unusual byte-access patterns due to splitting, narrow bursts, sparse byte enables, and other special transaction cases are automatically handled by the scoreboard since it tracks reads and writes on a per-byte basis.

According to one aspect of the present invention as shown in one embodiment of the invention, a generic interface can be optionally configured to support the limitations peculiar to one or more of the specific interface protocols to be supported. Configuration is done by choosing parameters that describe the interface protocol.

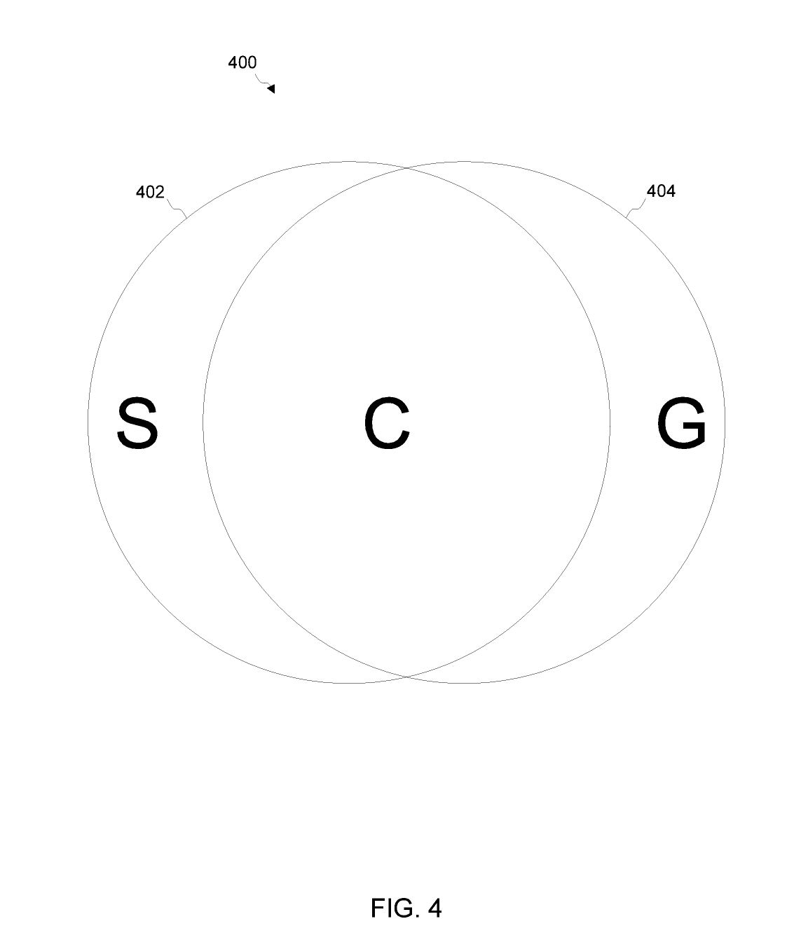

Naturally, VIP for a generic protocol cannot explicitly request transactions using every combination of features of a specific protocol. In FIG. 4 a feature space 400 is shown. It comprises the set of features supported by a specific protocol represented by circle 402 and the set of features supported by a generic protocol represented by circle 404. The set of features common to specific protocol 402 and the generic protocol 404 is labeled C, the set of features only supported by the specific protocol is labeled S, and the set of features only supported by the generic protocol is labeled G.

According to an aspect of the invention, the behavior of features set S is spontaneously randomized within the adapter for each transaction request issued by the driver. Feature set G is constrained not to be exercised. Feature set C is naturally exercised by the test.

In accordance with one aspect of the invention, the DUT and the adapter are written in the synthesizable subset of the Verilog language and the testbench is written in the System Verilog language. In accordance with another aspect, the DUT, adapter, and the testbench are written in the SystemC language. In accordance with yet another aspect, the DUT and adapter are written in Verilog and the testbench is written in SystemC.

As will be apparent to those of skill in the art upon reading this disclosure, each of the aspects described and illustrated herein has discrete components and features which may be readily separated from or combined with the features and aspects to form embodiments, without departing from the scope or spirit of the present invention. Any recited method can be carried out in the order of events recited or in any other order which is logically possible.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or system in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein.

In accordance with the teaching of the present invention a computer and a computing device are articles of manufacture. Other examples of an article of manufacture include: an electronic component residing on a mother board, a server, a mainframe computer, or other special purpose computer each having one or more processors (e.g., a Central Processing Unit, a Graphical Processing Unit, or a microprocessor) that is configured to execute a computer readable program code (e.g., an algorithm, hardware, firmware, and/or software) to receive data, transmit data, store data, or perform methods.

The article of manufacture (e.g., computer or computing device) includes a non-transitory computer readable medium or storage that includes a series of instructions, such as computer readable program steps or code encoded therein. In certain aspects of the present invention, the non-transitory computer readable medium includes one or more data repositories. Thus, in certain embodiments that are in accordance with any aspect of the present invention, computer readable program code (or code) is encoded in a non-transitory computer readable medium of the computing device. The processor, in turn, executes the computer readable program code to create or amend an existing computer-aided design using a tool. In other aspects of the embodiments, the creation or amendment of the computer-aided design is implemented as a web-based software application in which portions of the data related to the computer-aided design or the tool or the computer readable program code are received or transmitted to a computing device of a host.

An article of manufacture or system, in accordance with various aspects of the present invention, is implemented in a variety of ways: with one or more distinct processors or microprocessors, volatile and/or non-volatile memory and peripherals or peripheral controllers; with an integrated microcontroller, which has a processor, local volatile and non-volatile memory, peripherals and input/output pins; discrete logic which implements a fixed version of the article of manufacture or system; and programmable logic which implements a version of the article of manufacture or system which can be reprogrammed either through a local or remote interface. Such logic could implement either a control system either in logic or via a set of commands executed by a soft-processor.

Accordingly, the preceding merely illustrates the various aspects and principles of the present invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the various aspects discussed and described herein. Rather, the scope and spirit of present invention is embodied by the appended claims.

What is claimed is:

1. A non-transitory data storage medium for storing computer program code, the medium arranged to represent a computer program that, if executed by a computer, includes simulating:
an instance of a first verification intellectual property including an application programming interface;
an instance of a second verification intellectual property including the application programming interface;
an instance of a first adapter that implements a first specific protocol; and
an instance of a second adapter that implements a second specific protocol.

2. The non-transitory data storage medium of claim 1 wherein the first adapter is synthesizable.

3. The non-transitory data storage medium of claim 1 wherein the second specific protocol is different from the first.

4. The non-transitory data storage medium of claim 1 wherein the first verification intellectual property uses a generic protocol and the second verification intellectual property uses the generic protocol.

5. The non-transitory data storage medium of claim 4 wherein at least one feature of the generic transaction interface is configurable.

6. The non-transitory data storage medium of claim 1 further including simulating a byte-based scoreboard.

7. A method of verifying a chip design comprising:
generating a first instance of a generic protocol verification intellectual property;
generating a second instance of the generic protocol verification intellectual property;
generating an instance of a first adapter that implements a first specific protocol; and
generating an instance of a second adapter that implements a second specific protocol.

8. The method of claim 7 further comprising choosing parameters that configure the generic protocol.

9. The method of claim 7 wherein the second specific protocol is different from the first specific protocol.

10. The method of claim 7 wherein the computer program further simulates a byte-based scoreboard.

11. An apparatus comprising:
non-transitory computer-readable storage medium including an executable computer-readable program code instructions stored therein, the computer-readable program code including instructions, which when executed, perform the steps including:
simulating a first specific interface; and
simulating a second specific interface,
wherein the transactions of the first specific interface are translated to transactions of a generic protocol, and
the transactions of the second protocol interface are translated to transactions of the generic protocol.

12. The apparatus of claim 11 wherein at least one feature of the generic protocol is configurable.

13. The apparatus of claim 12 wherein the transactions of the generic protocol are one byte long.

14. The apparatus of claim 11, wherein the second specific interface uses a different protocol than the first specific interface.

15. The apparatus of claim 11 wherein the transactions of the generic protocol are one byte long.

16. The apparatus of claim 11, further comprising:
a device under test in communication with the storage medium; and
a scoreboard in communication with the storage medium,
wherein the first specific interface and the second specific interface are connected to the device under test and the scoreboard accepts transactions of the generic protocol.
